(19) United States
(12) Patent Application Publication
(10) Pub. No.: US 2014/0354704 A1
(43) Pub. Date: Dec. 4, 2014

(54) PIXEL, DRIVING METHOD OF THE PIXEL, AND DISPLAY DEVICE INCLUDING THE PIXEL

(71) Applicant: SAMSUNG DISPLAY CO., LTD., Yongin-City (KR)

(72) Inventor: Sang-Jin PAK, Yongin-City (KR)

(73) Assignee: SAMSUNG DISPLAY CO., LTD., Yongin-City (KR)

(21) Appl. No.: 14/064,634

(22) Filed: Oct. 28, 2013

(30) Foreign Application Priority Data
May 30, 2013 (KR) 10-2013-0062059

(51) Int. Cl. G09G 3/32

(52) U.S. Cl. CPC G09G 3/3291
USPC 345/690; 345/82

(57) ABSTRACT

A pixel of a display device includes: a first and second organic light emitting diodes; a driving transistor which generates a driving current based on a data voltage; and a luminance control transistor which controls an electric connection between the first and second organic light emitting diodes based on a first or second sub-data signal supplied through a sub-data line connected thereto, where when the data voltage is a first data voltage corresponding to a first grayscale, the first and second organic light emitting diodes emit light by the driving current based on the first data voltage in response to the first sub-data signal, and when the data voltage is a second data voltage corresponding to a second grayscale, the first organic light emitting diode emits light by the driving current based on the second data voltage in response to the second sub-data signal.

This application claims priority to Korean Patent Application No. 10-2013-0062059 filed on May 30, 2013, and all the benefits accruing therefrom under 35 U.S.C. §119, the content of which in its entirety is herein incorporated by reference.

### BACKGROUND

(a) Field

Exemplary embodiments of the invention relate to a pixel, a method of driving the pixel, and a display device including the pixel.

(b) Description of the Related Art

A method for driving an organic light emitting diode (“OLED”) may is typically classified into two methods. One of the two methods is an analog driving method that controls brightness by supplying a data voltage that corresponds to a grayscale to a pixel and a grayscale of an image is expressed according to the controlled brightness. The other of the two methods is a digital driving method that controls brightness of the pixel only by turning on/off the pixel and a grayscale is expressed by a spatial or temporal combination of turned-on/turned-off pixels.

In the analog driving method, improvement of a pixel per inch (“PPI”) may be limited due to a complex pixel structure. In addition, the analog driving method typically includes a process for discharging charges charged in the OLED, a process for compensating a threshold voltage of a driving transistor and a process for data programming and in realization of high resolution.

In the digital driving method, image sticking and long range uniformity (“LRU”) may occur due to deterioration of the OLED.

### SUMMARY

Exemplary embodiments relate to an organic light emitting diode (“OLED”) display device having high pixel per inch (“PPI”) and high resolution with improved long range uniformity (“LRU”) of the OLED display, in which mura is effectively prevented.

An exemplary embodiment of a pixel of a display device includes: a first organic light emitting diode; a second organic light emitting diode; a driving transistor which generates a driving current based on a data voltage supplied through a data line of the display device; and a luminance control transistor which controls an electric connection between the first organic light emitting diode and the second organic light emitting diode based on a first sub-data signal or a second sub-data signal supplied through a sub-data line connected thereto, where when the data voltage is a first data voltage corresponding to a first grayscale, the first organic light emitting diode and the second organic light emitting diode emit light by the driving current generated based on the first data voltage in response to the first sub-data signal, which corresponds to the first grayscale, and when the data voltage is a second data voltage corresponding to a second grayscale, the first organic light emitting diode emits light by the driving current generated based on the second data voltage in response to the second sub-data signal, which corresponds to the second grayscale.

In an exemplary embodiment, when the data voltage is a third data voltage corresponding to a third grayscale, at least the first organic light emitting diode may emit light by the driving current generated based on the third data voltage.

In an exemplary embodiment, the first organic light emitting diode and the second light emitting diode may be connected to each other in series, the luminance control transistor and the second organic light emitting diode may be connected to each other in parallel, and the luminance control transistor may be turned off by the first sub-data signal applied thereto.

In an exemplary embodiment, the first organic light emitting diode and the second organic light emitting diode may be connected to each other in series, the luminance control transistor and the second organic light emitting diode may be connected to each other in parallel, and the luminance control transistor may be turned on by the second sub-data signal applied thereto.

In an exemplary embodiment, the luminance control transistor may be connected between the first organic light emitting diode and the second organic light emitting diode, and the luminance control transistor may be turned on by the first sub-data signal of the pixel, such that the driving current may be divided and the divided driving current may flow to the first organic light emitting diode and the second organic light emitting diode, respectively.

In an exemplary embodiment, the luminance control transistor may be connected between the first organic light emitting diode and the second organic light emitting diode, and when the data voltage is the second data voltage corresponding to the second grayscale, the luminance control transistor may be turned off by the second sub-data signal of the pixel, such that the driving current may flow to the first organic light emitting diode.

In an exemplary embodiment, the pixel may further include a switching transistor including: a first electrode connected to the data line of the display device; a gate electrode connected to a gate line of the display device through which a gate signal is transmitted; and a second electrode connected to a gate electrode of the driving transistor; and a capacitive capacitor connected to the gate electrode and a first electrode of the driving transistor, where the capacitive capacitor may be charged by the data voltage transmitted during a turn-on period of the switching transistor, and the driving transistor may generate the driving current based on a voltage charged in the capacitive capacitor.

In an exemplary embodiment, the pixel further includes a light emission control transistor connected between a second electrode of the driving transistor and a first voltage, and a monitoring transistor connected between the data line and a node of the light emission control transistor and the driving transistor, where the second organic light emitting diode may be connected to a second voltage.

In an exemplary embodiment, a monitoring signal may be supplied to a gate electrode of the monitoring transistor, and an inverse monitoring signal may be supplied to the light emission control transistor.

In an exemplary embodiment, the pixel further includes a first switch connected to the data line, and a second switch connected between the data line and a read-out line, and while the switching transistor is being turned on, the data voltage may be supplied to the data line through the first switch, or while the monitoring transistor is being turned on, the driving current may flow to the read-out line through the second switch.

In an exemplary embodiment, the first data voltage and the second data voltage may be substantially equivalent to each other.

An exemplary embodiment of a display device includes: a plurality of data lines, which transmits a data voltage; a plurality of gate lines; a plurality of sub-data lines, which transmits a sub-data signal; a plurality of pixels, where each of the pixels is connected to a corresponding data line of the data lines, a corresponding gate line of the gate lines, and a corresponding sub-data line of the sub-data lines; and a signal controller which generates an image data signal, where the image data signal indicates whether the data voltage is a first data voltage corresponding to a first grayscale, a second data voltage corresponding to a second grayscale or a third voltage corresponding to a third grayscale, and whether the sub-data signal is a first sub-data signal corresponding to the first grayscale or a second sub-data signal corresponding to the second grayscale, based on a video signal supplied thereto, where each of the pixels includes: a first organic light emitting diode; a second organic light emitting diode; a driving transistor which generates a driving current based on the data voltage supplied through the corresponding data line; and a luminance control transistor which controls an electric connection between the first organic light emitting diode and the second organic light emitting diode based on the first sub-data signal or the second sub-data signal supplied through the corresponding sub-data line connected thereto.

In an exemplary embodiment, when the data voltage is the first data voltage corresponding to the first grayscale, the first organic light emitting diode and the second organic light emitting diode may emit light by the driving current generated based on the first data voltage in response to the first sub-data signal, when the data voltage is the second data voltage corresponding to the second grayscale, the first organic light emitting diode may emit light by the driving current generated based on the second data voltage in response to the second sub-data signal, and when the data voltage is the third data voltage corresponding to the third grayscale at least the first organic light emitting diode may emit light by the driving current generated based on the third data voltage.

In an exemplary embodiment, the pixel may further include a light emission control transistor connected between the driving transistor and a first voltage; and a monitoring transistor connected between the corresponding data line and a node of the light emission control transistor and the driving transistor, the second organic light emitting diode may be connected to a second voltage, and the driving current generated in the driving transistor based on the first data voltage may be transmitted through a turned-on monitoring transistor, and the first data voltage may be controlled to allow the driving current to be substantially equal to a predetermined reference current.

An exemplary embodiment of a method for driving a pixel of a display device includes: coupling a first organic light emitting diode and a second organic light emitting diode of the pixel in series in response to a first sub-data signal corresponding to a first grayscale supplied to the pixel, and flowing a driving current generated by a driving transistor of the pixel based on a first data voltage corresponding to the first grayscale to the first organic light emitting diode and the second organic light emitting diode; and flowing the driving current generated by the driving transistor of the pixel based on a second data voltage corresponding to a second grayscale to the first organic light emitting diode in response to a second sub-data signal corresponding to the second grayscale supplied to the pixel.

In an exemplary embodiment, the method may further include flowing a third driving current generated by the driving transistor of the pixel based on a third data voltage corresponding to a third grayscale to at least the first organic light emitting diode.

According to exemplary embodiments of the invention, an OLED display device has high PPI and high resolution, and LRU of the OLED display is substantially improved and mura is effectively prevented.

### BRIEF DESCRIPTION OF THE DRAWINGS

The above and other features of the invention will become more apparent by describing in detail exemplary embodiments thereof with reference to the attached drawings, in which:

FIG. 1 is a circuit diagram showing an exemplary embodiment of a pixel circuit according to the invention;

FIG. 2 is a waveform diagram of an exemplary embodiment of signals in a predetermined period including a monitoring period of the pixel circuit shown in FIG. 1;

FIG. 3 is a waveform diagram of signals when an exemplary embodiment of a pixel emits light with gray luminance;

FIG. 4 is a waveform diagram of signals when an exemplary embodiment of the pixel emits light with white luminance;

FIG. 5 is a circuit diagram showing an alternative exemplary embodiment of a pixel according to the invention; and

FIG. 6 is a block diagram showing an exemplary embodiment of a display device according to the invention.

### DETAILED DESCRIPTION

The invention will be described more fully hereinafter with reference to the accompanying drawings, in which embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, an exemplary embodiment of a pixel circuit, a display device including the pixel, and a method for driving the display device will be described with reference to the accompanying drawings.

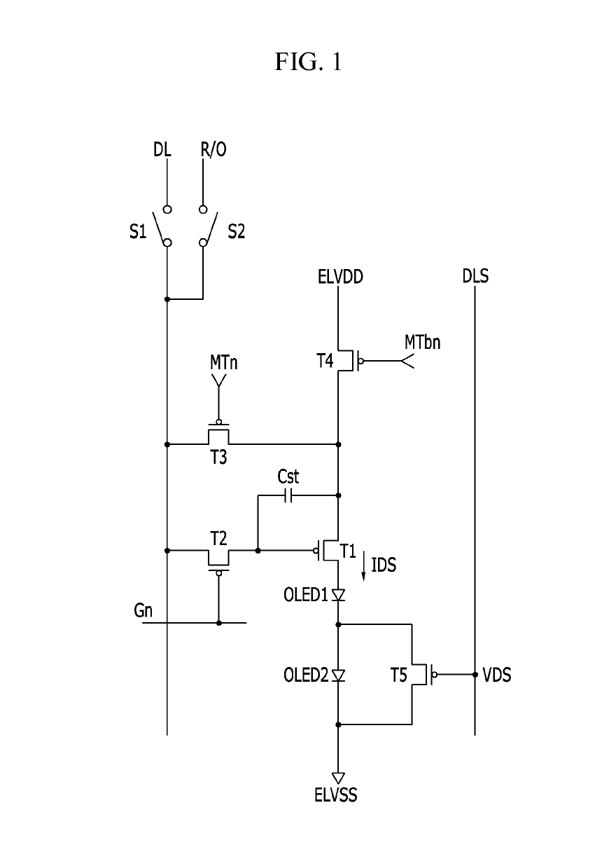

FIG. 1 is a circuit diagram showing an exemplary embodiment of a pixel circuit according to the invention.

As shown in FIG. 1, an exemplary embodiment of a pixel includes a driving transistor T1, a switching transistor T2, a monitoring transistor T3, a light emission control transistor T4, a luminance control transistor T5, a capacitive capacitor CST, a first organic light emitting diode OLED1 and a second organic light emitting diode OLED2.

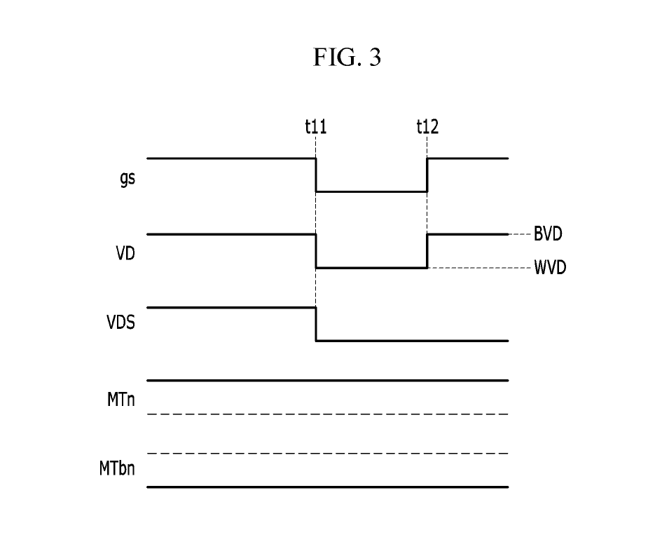

The pixel is connected to a data line DL. The data line DL is connected to a data voltage VD (shown in FIG. 3) through a first switch S1 or connected to a read-out line R/O through a second switch S2.

The data voltage VD is supplied to the data line DL during a turn-on period of the first switch S1, and a current flowing through the data line DL flows to the read-out line R/O during a turn-on period of the second switch S2 when the first switch S1 is turned off.

The second switch S2 is in a turn-off state during the turn-on period of the switch S1, and the switch S1 is in a turn-off state during the turn-on period of the switch S2. The data voltage VD in light emission with a full-white grayscale is determined based on, e.g., by monitoring, the current flowing through the read-out line R/O.

The full-white grayscale is a grayscale corresponding to luminance set to the highest luminance among grayscales displayed by the pixel. In such an embodiment, the data voltage VD is set to a voltage corresponding to the full-white grayscale to display the full-white grayscale. In one exemplary embodiment, for example, when the pixel emits light with luminance corresponding to the full-white grayscale, a voltage supplied to the data line DL is set to a data voltage VD of the full-white grayscale.

Hereinafter, the data voltage of the full-white grayscale is referred to as a white data voltage WVD (shown in FIG. 3), and a data voltage VD set for the pixel to emit light with the lowest grayscale (e.g., black) is referred to as a black data voltage BVD (shown in FIG. 3). The black data voltage BVD may be set to a voltage that substantially completely or effectively turns off the driving transistor T1.

The first organic light emitting diode OLED1 is a current driving element, and emits light with luminance corresponding to a current flowing thereto. In such an embodiment, the first organic light emitting diode OLED1 emits light by a driving current IDS generated based on the white data voltage WVD supplied to the driving transistor T1.

In an exemplary embodiment, as shown in FIG. 1, the first organic light emitting diode OLED1 and a second organic light emitting diode OLED2 are coupled in series, such that the driving current IDS flows to the second organic light emitting diode OLED2 when the luminance control transistor T5 is turned off. In such an embodiment, the second organic light emitting diode OLED2 and the first organic light emitting diode OLED1 may have substantially the same size as each other, and the second organic light emitting diode OLED2 emits light with substantially the same luminance as the first organic light emitting diode OLED1.

The first organic light emitting diode OLED1 emits light with the lowest luminance by the driving current IDS that corresponds to the black data voltage BVD supplied to the driving transistor T1. In such an embodiment, when the first organic light emitting diode OLED1 emits light with the lowest luminance, the luminance control transistor T5 may be in a turn-on state. However, the invention is not limited thereto, and the luminance control transistor T5 may be in a turn-off state in the lowest luminance in an alternative exemplary embodiment. The turn-on/turn-off state in the lowest luminance of the luminance control transistor T5 may be determined based on a predetermined value corresponding to the lowest luminance.

In an exemplary embodiment, the first organic light emitting diode OLED1 and the second organic light emitting diode OLED2 are coupled in series, and the white data voltage WVD or the black data voltage BVD is input to the pixel. The second organic light emitting diode OLED2 may emit light or may not emit light based on a switching operation of the luminance control transistor T5. In such an embodiment, the pixel expresses three luminances.

When the data voltage VD is the black data voltage BVD, the luminance of the pixel is the lowest luminance. When the data voltage VD is the white data voltage WVD and the luminance control transistor T5 is in the turn-on state, the luminance of the pixel is an intermediate luminance, e.g., a luminance between the lowest luminance and the highest luminance. When the data voltage VD is the white data voltage WVD and the luminance control transistor T5 is in the turn-off state, the luminance of the pixel is the highest luminance. Hereinafter, the lowest luminance is referred to as a black grayscale, the intermediate luminance is referred to as a gray grayscale, and the highest luminance is referred to as a white grayscale.

A sub-data signal VDS is a signal that controls the switching operation of the luminance control transistor T5. A level of the sub-data signal VDS is a disable level when the pixel displays the gray grayscale, and a level of the sub-data signal VDS is an enable level when the pixel displays the white grayscale.

As described, in such an embodiment, the pixel emits light in one of black, gray and white grayscales.

Referring to FIG. 1, a structure of an exemplary embodiment of the pixel will be described. As shown in FIG. 1, a source electrode and a gate electrode of the driving transistor T1 are connected to the capacitive capacitor Cst. The gate electrode of the driving transistor T1 is connected to the data line DL through the switching transistor T2.

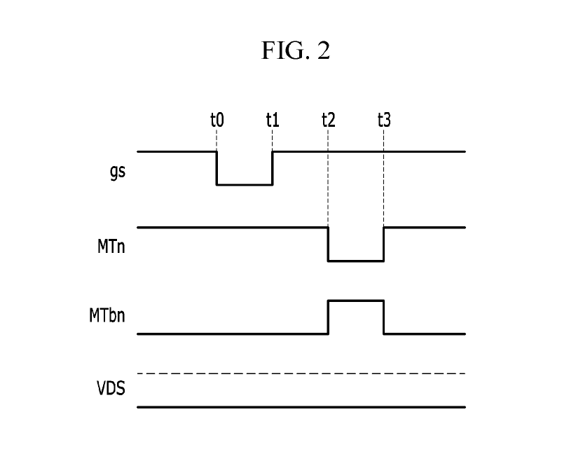

A gate electrode of the switching transistor T2 is connected to a gate line Gn, and a gate signal gs (shown in FIG. 2) is supplied through the gate line Gn. When the switching transistor T2 is turned on by the gate signal gs, the data voltage VD is supplied to the gate electrode of the driving transistor T1 through the data line DL.

A drain electrode of the driving transistor T1 is connected to an anode of the first organic light emitting diode OLED1, a cathode of the first organic light emitting diode OLED1 is connected to an anode of the second organic light emitting diode OLED2, and a cathode of the second organic light emitting diode OLED2 is connected to a second voltage ELVSS.

The luminance control transistor T5 is coupled in parallel with lateral ends of the second organic light emitting diode OLED2. A gate electrode of the luminance control transistor T5 is connected to a sub-data line DLS, and the luminance control transistor T5 performs the switching operation based on the sub-data signal VDS transmitted through the sub-data line DLS.

The source electrode of the driving transistor T1 is connected to a first voltage ELVDD through the light emission control transistor T4, and the monitoring transistor T3 is connected between the data line DL and the source electrode of the driving transistor T1. A monitoring signal MTn is supplied to a gate electrode of the monitoring transistor T3 to control a switching operation of the monitoring transistor T3. An inverse monitoring signal MTbn is supplied to a gate electrode of the light emission control transistor T4 to control a switching operation of the light emission control transistor T4.

In an exemplary embodiment, the switching transistor T2, the monitoring transistor T3, the light emission control transistor T4 and the luminance control transistor T5 are P-type channel transistors, and turned on by a low-level signal. In such an embodiment, when the gate signal gs is a low-level signal, the switching transistor T2 is turned on, and when the monitoring signal MTn is a low-level signal, the monitoring transistor T3 is turned on. In such an embodiment, when the inverse monitoring signal MTbn is a low-level signal, the light emission control transistor T4 is turned on, and when the sub-data signal VDS is a low-level signal, the luminance control transistor T5 is turned on.

FIG. 2 is a waveform diagram illustrating waveforms of an exemplary embodiment of signals in a predetermined period including a monitoring period of the pixel shown in FIG. 1.

As shown in FIG. 2, the gate signal gs becomes low level at an initial time point t0, and thus the switching transistor T2 is turned on. In such an embodiment, the monitoring signal MTn is high level and the inverse monitoring signal MTbn is low level at the initial time point t0, such that the data voltage VD is supplied to the gate electrode of the driving transistor T1 and the source electrode of the driving transistor T1 is connected to the second voltage ELVDD. Then, the driving current IDS that corresponds to a difference between the second voltage ELVDD and the data voltage VD supplied to the gate electrode of the driving transistor T1 is supplied to the first organic light emitting diode OLED1.

As shown in the waveform in FIG. 2, the sub-data signal VDS is set to be maintained in low level during the predetermined period including the monitoring period. In an exemplary embodiment, the light emission luminance of the first organic light emitting diode OLED1 and the light emission luminance of the second organic light emitting diode OLED2 may be substantially the same as each other with respect to substantially the same driving current, and monitoring of the light emission luminance of only the first organic light emitting diode OLED1 will now be described.

However, the invention is not limited thereto, and the monitoring operation may be performed when the sub-data signal VDS is maintained in a high level in an alternative exemplary embodiment.

At a first time point t1 after the initial time point t0, the gate signal gs is increased to a high level, and thus the gate electrode of the driving transistor T1 and the data line DL are disconnected, and the driving transistor T1 supplies a driving current IDS that corresponds to a voltage stored in the capacitive capacitor Cst to the first organic light emitting diode OLED1. During a period between the first time point t1 to a second time point t2, the first switch S1 is turned on, and thus the data voltage VD is supplied to the data line DL.

At the second time point t2, the monitoring signal MTn is decreased to low level and the inverse monitoring signal MTbn is increased to a high level. Then, the monitoring transistor T3 is turned on and the light emission control transistor T4 is turned off. The second switch S2 is turned on at the second time point t2, and the driving current IDS flows through the read-out line R/O.

In one exemplary embodiment, for example, the first voltage ELVDD is supplied through the read-out line R/O at the second time point t2, the driving current IDS flows to the monitoring switch T3, the driving transistor T1 and the first organic light emitting diode OLED1 through the read-out line R/O.

Then, the driving current IDS flowing in the read-out line R/O is detected, and the detected driving current may be compared with a predetermined current, with which the first organic light emitting diode OLED1 emits light with luminance of the full-white grayscale, to determine whether the detected driving current and the predetermined current are substantially the same as each other, and the white data voltage WVD may be set by controlling the data voltage VD based on a result of the comparison.

At a third time point t3, the monitoring signal MTn is increased to a high level and the inverse monitoring signal MTbn is decreased to low level. As described above, the driving current IDS flows through the read-out line R/O and then is sensed during a period between the second time point t2 to the third time point t3. The period between the second time point t2 to the third time point t3 may be referred to as a monitoring period.

In one exemplary embodiment, for example, the display device may sense a driving current IDS flowing through the read-out line R/O and compensate a data voltage VD based on a comparison result of the sensed driving current IDS and a reference current, e.g., the predetermined current, with which the first organic light emitting diode OLED1 emits light with luminance of the full-white grayscale. The data voltage VD may be decreased or increased with a predetermined unit voltage (e.g., by a voltage, which is n times the predetermined unit voltage, where n is a natural number) to allow the driving current IDS to be substantially equivalent to the reference current.

In one exemplary embodiment, for example, the display device may decrease the data voltage VD with a predetermined unit voltage when the driving current IDS is lower than the reference current, and may increase the data voltage VD with a predetermined unit voltage when the driving current IDS is higher than the reference current.

In such an embodiment, as described above, a voltage corresponding to the increased or decreased data voltage when the reference current and the driving current IDS substantially equal to each other is detected, is set as the white data voltage WVD.

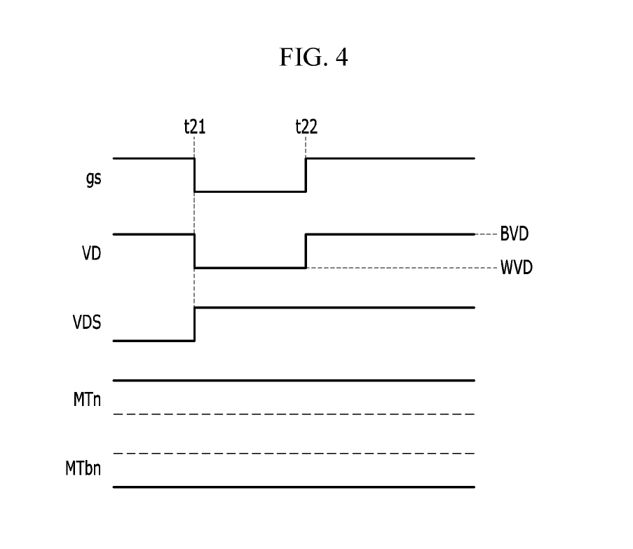

Hereinafter, an operation of an exemplary embodiment of the pixel will be described with reference to FIG. 3 and FIG. 4.

FIG. 3 is a waveform diagram illustrating signals when an exemplary embodiment of the pixel emits light with gray luminance. FIG. 3 shows waveforms of the monitoring signal, the inverse monitoring signal, the gate signal, the data voltage and the sub-data signal.

When the pixel emits light with gray luminance, the monitoring signal MTn is high level and the inverse monitoring signal MTbn is low level.

At a first time point t11, the gate signal gs is decreased to low level, and the switching transistor T2 is thereby turned on such that then the data voltage VD is transmitted to the gate electrode of the driving transistor T1. In such an embodiment, the data voltage VD may be a white data voltage WVD. The driving transistor T1 generates a driving current IDS corresponding to a difference between the white data voltage WVD and the first voltage ELVDD. In such an embodiment, the sub-data signal VDS is decreased to low level at the first time point t11, and the luminance control transistor T5 is thereby turned on such that the driving current IDS flows through the turn-on luminance control transistor T5 rather than flowing to the second organic light emitting diode OLED2.

At a second time point t12, the gate signal gs is increased to a high level, and the switching transistor T2 is thereby turned off, and the data voltage VD is increased to the black data voltage BVD. The sub-data signal VDS is maintained in the low level while the pixel emits light with the gray luminance, and thus the luminance control transistor T5 is in a turn-on state.

FIG. 4 is a waveform diagram of signals when an exemplary embodiment of the pixel emits light with white luminance. FIG. 4 illustrates waveforms of the monitoring signal, the inverse monitoring signal, the gate signal, the data voltage and the sub-data signal.

When the pixel emits light with white luminance, the monitoring signal MTn is high level and the inverse monitoring signal MTbn is low level.

At a first time point t21, the gate signal gs is decreased to a low level and the switching transistor T2 is thereby turned on such that a data voltage VD is transmitted to the gate electrode of the driving transistor T1. In such an embodiment, the data voltage VD is the white data voltage WVD. The driving transistor T1 generates a driving current IDS corresponding to a difference between the white data voltage WVD and the first voltage ELVDD.

The sub-data signal VDS is increased to a high level at the first time point t21, and the luminance control transistor T5 is thereby turned off. Then, the driving current IDS flows to the first and second organic light emitting diodes OLED1 and OLED2, such that the pixel emits light with white luminance that is two times the gray luminance shown in FIG. 3.

At a second time point t22, the gate signal gs is increased to a high level and thus the switching transistor T2 is turned off, and the data voltage VD is increased to the black data voltage BVD. The sub-data signal VDS is maintained in the high level while the pixel emits light with the white luminance, and thus the luminance control transistor T5 is in a turn-off state.

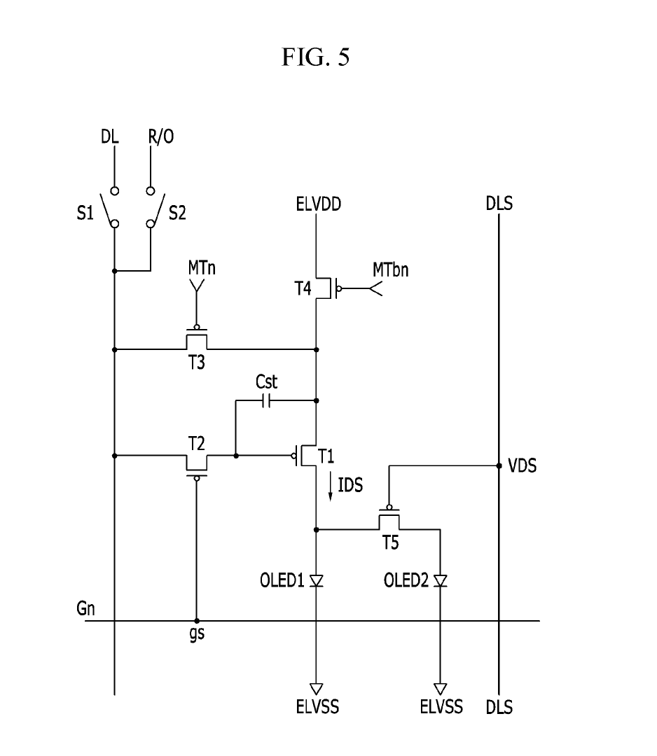

Hereinafter, an alternative exemplary embodiment of a pixel according to the invention will be described with reference to FIG. 5.

FIG. 5 is a circuit diagram showing an alternative exemplary embodiment of a pixel.

The pixel in FIG. 5 is substantially the same as the pixel shown in FIG. 1 except for the first and second organic light emitting diodes OLED1 and OLED2. The same or like elements shown in FIG. 5 have been labeled with the same reference characters as used above to describe the exemplary embodiments of the pixel in FIG. 1, and any repetitive detailed description thereof will hereinafter be omitted or simplified. In an alternative exemplary embodiment of a pixel, the first organic light emitting diode OLED1 and the second organic light emitting diode OLED2 are connected in parallel with each other.

In such an embodiment, as shown in FIG. 5, the drain electrode of the driving transistor T1 is connected to the anode of the first organic light emitting diode OLED1 and the source electrode of the luminance control transistor T5.

In such an embodiment, as shown in FIG. 5, the gate electrode of the luminance control transistor T5 is supplied with the sub-data voltage VDS. In such an embodiment, as shown in FIG. 5, the drain electrode of the luminance control transistor T5 is connected to the anode of the second organic light emitting diode OLED2, and the cathodes of the first and second organic light emitting diodes OLED1 and OLED2 are connected to the first voltage ELVDD through the light emission control transistor T4 and the driving transistor T1.

In such an embodiment, on-resistance of the driving transistor T1 is set to be substantially greater than on-resistance of the first organic light emitting diode OLED1 and on-resistance of the second organic light emitting diode OLED2. During the turn-on period of the luminance control transistor T5, the driving current IDS is divided and the divided driving currents flow the first organic light emitting diode OLED1 and the second organic light emitting diode OLED2, respectively.

In such an embodiment, the luminance control transistor T5 may be a P-channel type transistor, and the luminance control transistor T5 may be turned on by a low-level sub-data signal VDA and turned off by a high-level sub-data signal VDS.

During a turn-off period of the luminance control transistor T5, a driving current IDS flows only to the first organic light emitting diode OLED1.

During a turn-on period of the luminance control transistor T5, flow of the driving current IDS is divided and applied to the first organic light emitting diode OLED1 and the second organic light emitting diode OLED2. When the on-resistance of the first organic light emitting diode OLED1 and the on-resistance of the second organic light emitting diode OLED2 are substantially the same, about an half of the driving current IDS flows to each of the first organic light emitting diode OLED1 and the second organic light emitting diode OLED2.

During a turn-on period of the luminance control transistor T5, a voltage level of a data voltage supplied to a gate electrode of the driving transistor T1 may be different from a voltage level of the white data voltage WVD in the turn-off period of the luminance control transistor T5 for light emission of the pixel with white luminance.

In such an embodiment, each of the first organic light emitting diode OLED1 and the second organic light emitting diode OLED2 is supplied with about an half of the driving current IDS, and about an half of the driving current IDS may have a voltage level that allows each of the first organic light emitting diode OLED1 and the second organic light emitting diode OLED2 to emit light with luminance corresponding to a full-white gray.

Accordingly, in an exemplary embodiment, the driving current IDS of the turn-on period of the luminance control transistor T5 is about two times the driving current IDS of the turn-off period of the luminance control transistor T5. In such an embodiment, the white data voltage WVD of the turn-on period of the luminance control transistor T5 may be changed to a level different from the white data voltage WVD of the turn-off period of the luminance control transistor T5. In one exemplary embodiment, for example, the driving transistor T1 is a p-type metal-oxide-semiconductor (“PMOS”) transistor, and the data voltage VD of the turn-on period of the luminance control transistor T5 is changed to a lower level such that the driving current IDS of the turn-on period of the luminance control transistor T5 is increased about two times the driving current IDS of the turn-off period of the luminance control transistor T5.

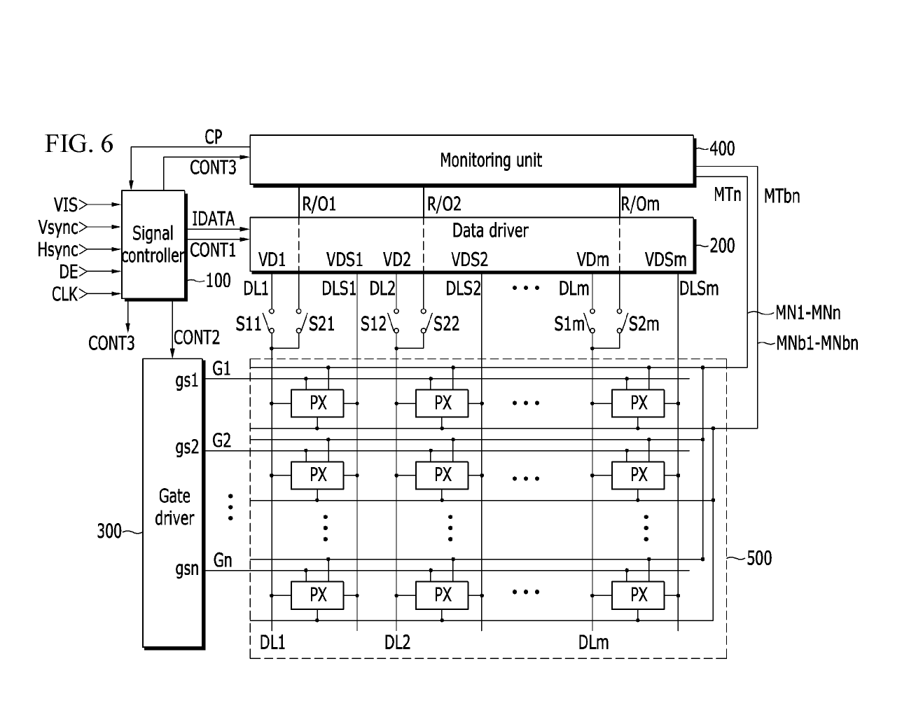

Hereinafter, an exemplary embodiment of a display device including the pixel will be described with reference to FIG. 6.

FIG. 6 is a block diagram showing an exemplary embodiment a display device according to the invention.

A pixel PX of FIG. 6 may be substantially the same as the exemplary embodiment of the pixel shown in FIG. 1 or the exemplary embodiment of the pixel shown in FIG. 5. Therefore, any repetitive detailed description of the pixel PX will hereinafter be omitted.

In an exemplary embodiment, a display device includes a signal controller 100, a data driver 200, a gate driver 300, a monitoring unit 400 and a display unit 500.

The signal controller 100 generates a first driving control signal CONT1, a second driving control signal CONT2 and a third driving control signal CONT3 for controlling an operation of displaying an image based on a vertical synchronization signal Vsync for defining a frame of an image, a horizontal synchronization signal Hsync for defining lines of one frame, a data enable signal DE for controlling a period for applying a data voltage to a plurality of data lines DL1 to DLm, a clock signal CLK for controlling a driving frequency.

In such an embodiment, the signal controller 100 determines light emission luminance of each of the plurality of pixels PX based on a video signal VIS, and generates an image data signal IDATA that determines a data voltage VD and a sub-data signal VDS of each of the plurality of pixels PX.

In one exemplary embodiment, for example, when a pixel PX emits light with a white grayscale based on the video signal VIS, a portion of the image data signal IDATA, which corresponds to the pixel PX that emits light with the white grayscale, indicates a white data voltage WVD and the sub-data signal VDS of an enable level. In such an embodiment, when a pixel PX emits light with gray grayscale based on the video signal VIS, a portion of an image data signal IDATA, which corresponds to the pixel PX emitting light with gray grayscale, indicates the white data voltage WVD and a sub-data signal VDS of a disable level. In such an embodiment, when a pixel PX emits light with black luminance based on the video signal VIS, a portion of the image data signal IDATA, which corresponds to the pixel PX emitting light with black grayscale, indicates a black data voltage BVD.

In such an embodiment, as described above, the signal controller 100 arranges data corresponding to each pixel PX based on the video signal VIS to thereby generate the image data signal IDATA.

The data driver 200 converts the image data signal IDATA into a plurality of data voltages VD1 to VDm and a plurality of sub-data signals VDS1 to VDSm by sampling and holding the image data signal IDATA based on the first driving control signal CONT1, and transmits the data voltages VD1 to VDm and sub-data signals VDS1 to VDSm to a plurality of data lines DL1 to DLm and a plurality of sub-data lines DLS1 to DLSm, respectively, based on the first driving control signal CONT1.

The gate driver 300 generates and transmits a plurality of gate signals gs1 to gsn as a low level pulse corresponding to scan timings of the gate lines G1 to Gn based on the second driving control signal CONT2.

The monitoring unit 400 generates a high-level monitoring signal MTn that turns off the monitoring transistor T3 and a low-level inverse monitoring signal MTbn that turns on the light emission control transistor T4 based on the third driving control signal CONT3.

In an exemplary embodiment, as shown in FIG. 6, a monitor line MN and a light emission control light MNb are connected to the pixels PX, the monitoring signal MTn is transmitted to the pixels PX through the monitor line MN, and the inverse monitoring signal MTbn is transmitted to the pixels PX through the light emission control line MNb.

In such an embodiment, the signal controller 100 generates the first driving control signal CONT1, the second driving control signal CONT2 and the third driving control signal CONT3 for controlling the monitoring operation.

A first end of each of a plurality of switches S21 to S2m is connected to a corresponding data line of the data lines DL1 to DLm, and a second end of each of the switches S21 to S2m is connected to a corresponding read-out line of a plurality of read-out lines R/O1 to R/Om based on the driving timing as shown in FIG. 2 when the monitoring operation is performed. Driving currents of the pixels PX are transmitted to the monitoring unit 400 through the read-out lines R/O1 to R/Om, respectively.

In one exemplary embodiment, for example, first ends of the switches S11 to S1m are connected to the data lines DL1 to DLm, respectively, and second ends of the switches S11 to S1m are connected to the plurality of data lines DL1 to DLm, respectively, based on the driving timing shown in FIG. 2 when the monitoring operation is performed. In an exemplary embodiment, a white data voltage is transmitted to each of the pixels PX through the data lines DL1 to DLm. In such an embodiment, the white data voltage may be a voltage that is controlled based on the monitoring operation.

During the monitoring operation, the data driver 200 converts an image data signal IDATA that indicates the white data voltage controlled by the signal controller 100 into the data voltages VD1 to VDm based on the first driving control signal CONT1, and transmits the data voltages VD1 to VDm to the data lines DL1 to DLm, respectively.

In such an embodiment, as described in FIG. 2, the sub-data signals VDS1 to VDSm may be maintained in the disable level during the monitoring operation. However, the invention is not limited thereto.

During the monitoring operation, the gate driver 300 generates the gate signals gs1 to gsn, and transmits the gate signals gs1 to gsn to the gate lines G1 to Gn based on the second driving control signal CONT2.

The monitoring unit 400 senses driving currents transmitted through the read/out lines R/O1 to R/Om based on the third driving control signal CONT3, and generates a result of comparison between the sensed driving currents and a reference current. A comparison signal CP that indicates the comparison result is transmitted to the signal controller 100. The signal controller 100 controls the white data voltage based on the comparison signal CP.

The display unit 500 includes the gate lines G1 to Gn, the data lines D1 to Dm, the sub-data lines DLS1 to DLSm, a plurality of sub-monitor lines MN1 to MNn, a plurality of sub-light emission control lines MNb1 to MNbn, and the pixels PX.

Each of the gate lines G1 to Gn extends substantially in a horizontal direction, and the gate lines S1 to Sn are arranged substantially along a vertical direction in the display unit 500. Each of the data lines DL1 to DLm extends substantially in the vertical direction, and the data lines DL1 to DLm are arranged substantially along the horizontal direction in the display unit 500. Each of the sub-data lines DLS1 to DLSm extends substantially in the vertical direction, and the sub-data lines DLS1 to DLSm are arranged substantially along the horizontal direction in the display unit 500.

A first data line DL1 of the data lines DL1 to DLm and a first sub-data line DLS1 of the plurality of sub-date lines DLS1 to DLSm may be arranged substantially parallel to each other, interposing a column of pixel PX therebetween.

Each of the sub-monitor lines MN1 to MNn extends substantially in the horizontal direction, and each of the sub-monitor lines MN1 to MNn are arranged substantially along the vertical direction in the display unit 500.

Each of the sub-light emission control lines MNb1 to MNbn extends substantially in the horizontal direction and the sub-light emission control lines MNb1 to MNbn are arranged substantially along the vertical direction in the display unit 500.

Each of the pixels PX is connected to a corresponding gate line of the gate lines G1 to Gn, a corresponding data line of the data lines DL1 to DLm, a corresponding sub-data line of the sub-date lines DLS1 to DLSm, a corresponding to sub-monitor line of the sub-monitor lines MN1 to MNn, and a corresponding sub-light emission control line of the sub-light emission control lines MNb1 to MNbn.

In such an embodiment, the display device may detect a white data voltage for each pixel through the monitoring operation, and a pixel of the display device may emit light with luminance corresponding to the gray grayscale by emitting light selectively from two organic light emitting diodes disposed on each pixel.

In such an embodiment, the display device may display grayscales using a plurality of sub-frames based on a digital driving method, and the number of the sub-frames for displaying an image including a number of grayscale levels (e.g., 256 grayscale levels) may be substantially reduced by the pixel that may display three grayscales including the black scale, the gray grayscale and the white grayscale.

Pixels using a conventional digital driving method are typically driven by simply being turned on/off, that is, light emission and non-light emission, but an exemplary embodiment of the pixel realizes three grayscales such that the number of sub-frames for an image having a predetermined grayscale levels may be reduced.

According to another exemplary embodiment, a driving method having combination of a digital driving method and an analog driving method may be provided. Then, an OLED display having high PPI and high resolution may be provided by overcoming the disadvantages of the digital driving method and the analog driving method, LRU of the OLED display is substantially improved and mura is effectively prevented.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A pixel of a display device comprising:
a first organic light emitting diode;
a second organic light emitting diode;
a driving transistor which generates a driving current based on a data voltage supplied through a data line of the display device; and
a luminance control transistor which controls an electric connection between the first organic light emitting diode and the second organic light emitting diode based on a first sub-data signal or a second sub-data signal supplied through a sub-data line connected thereto,
wherein
when the data voltage is a first data voltage corresponding to a first grayscale, the first organic light emitting diode and the second organic light emitting diode emit light by the driving current generated based on the first data voltage in response to the first sub-data signal, which corresponds to the first grayscale, and
when the data voltage is a second data voltage corresponding to a second grayscale, the first organic light emitting diode emits light by the driving current generated based on the second data voltage in response to the second sub-data signal, which corresponds to the second grayscale.

2. The pixel of claim 1, wherein when the data voltage is a third data voltage corresponding to a third grayscale, at least the first organic light emitting diode emits light by the driving current generated based on a third data voltage.

3. The pixel of claim 1, wherein
the first organic light emitting diode and the second light emitting diode are connected to each other in series,
the luminance control transistor and the second organic light emitting diode are connected to each other in parallel, and
the luminance control transistor is turned off by the first sub-data signal.

4. The pixel of claim 1, wherein
the first organic light emitting diode and the second organic light emitting diode are connected to each other in series,
the luminance control transistor and the second organic light emitting diode are connected to each other in parallel, and
the luminance control transistor is turned on by the second sub-data signal applied thereto.

5. The pixel of claim 1, wherein
the luminance control transistor is connected between the first organic light emitting diode and the second organic light emitting diode, and
when the data voltage is the first data voltage corresponding to the first grayscale, the luminance control transistor is turned on by the first sub-data signal of the pixel, such that the driving current is divided and the divided driving currents flow to the first organic light emitting diode and the second organic light emitting diode, respectively.

6. The pixel of claim 1, wherein
the luminance control transistor is connected between the first organic light emitting diode and the second organic light emitting diode, and
when the data voltage is the second data voltage corresponding to the second grayscale, the luminance control transistor is turned off by the second sub-data signal of the pixel, such that the driving current flows to the first organic light emitting diode.

7. The pixel of claim 1, further comprising:
a switching transistor comprising:
a first electrode connected to the data line of the display device;
a gate electrode connected to a gate line of the display device through which a gate signal is transmitted; and
a second electrode connected to a gate electrode of the driving transistor; and
a capacitive capacitor connected to the gate electrode and a first electrode of the driving transistor,
wherein
the capacitive capacitor is charged by the data voltage transmitted during a turn-on period of the switching transistor, and
the driving transistor generates the driving current based on a voltage charged in the capacitive capacitor.

8. The pixel of claim 7, further comprising:
a light emission control transistor connected between a second electrode of the driving transistor and a first voltage; and
a monitoring transistor connected between the data line and a node of the light emission control transistor and the driving transistor.

9. The pixel of claim 8, wherein
a monitoring signal is supplied to a gate electrode of the monitoring transistor, and
an inverse monitoring signal is supplied to the light emission control transistor.

10. The pixel of claim 9, further comprising:
a first switch connected to the data line; and
a second switch connected between the data line and a read-out line of the display device,
wherein while the switching transistor is being turned on, the data voltage is supplied to the data line through the first switch, and
wherein while the monitoring transistor is being turned on, the driving current flows to the read-out line through the second switch.

11. The pixel of claim 1, wherein the first data voltage and the second data voltage are substantially equivalent to each other.

12. A display device comprising:
a plurality of data lines, which transmits a data voltage;
a plurality of gate lines;
a plurality of sub-data lines, which transmits a sub-data signal;
a plurality of pixels, wherein each of the pixels is connected to a corresponding data line of the data lines, a corresponding gate line of the gate lines, and a corresponding sub-data line of the sub-data lines; and
a signal controller which generates an image data signal,
wherein the image data signal indicates
whether the data voltage is a first data voltage corresponding to a first grayscale, a second data voltage corresponding to a second grayscale or a third voltage corresponding to a third grayscale, and
whether the sub-data signal is a first sub-data signal corresponding to the first grayscale or a second sub-data signal corresponding to the second grayscale, based on a video signal supplied thereto, and
wherein each of the pixels comprises:
a first organic light emitting diode;
a second organic light emitting diode;
a driving transistor which generates a driving current based on the data voltage supplied through the corresponding data line; and
a luminance control transistor which controls an electric connection between the first organic light emitting diode and the second organic light emitting diode based on the first sub-data signal or the second sub-data signal supplied through the corresponding sub-data line connected thereto.

13. The display device of claim 12, wherein
when the data voltage is the first data voltage corresponding to the first grayscale, the first organic light emitting diode and the second organic light emitting diode emit light by the driving current generated based on the first data voltage in response to the first sub-data signal,
when the data voltage is the second data voltage corresponding to the second grayscale, the first organic light emitting diode emits light by the driving current generated based on the second data voltage in response to the second sub-data signal, and
when the data voltage is the third data voltage corresponding to the third grayscale at least the first organic light emitting diode emits light by the driving current generated based on the third data voltage.

14. The display device of claim 12, wherein
the first organic light emitting diode and the second light emitting diode are connected to each other in series,
the luminance control transistor and the second organic light emitting diode are connected to each other in parallel, and
the luminance control transistor is turned off by the first sub-data signal.

15. The display device of claim 12, wherein
the first organic light emitting diode and the second organic light emitting diode are connected to each other in series,
the luminance control transistor and the second organic light emitting diode are connected to each other in parallel, and
the luminance control transistor is turned on by the second sub-data signal.

16. The display device of claim 12, wherein
the luminance control transistor is connected between the first organic light emitting diode and the second organic light emitting diode, and
when the data voltage is the first data voltage corresponding to the first grayscale, the luminance control transistor is turned on by the first sub-data signal of the pixel, such that the driving current is divided and the divided driving currents flow to the first organic light emitting diode and the second organic light emitting diode, respectively.

17. The display device of claim 12, wherein
the luminance control transistor is connected between the first organic light emitting diode and the second organic light emitting diode, and
when the data voltage is the second data voltage corresponding to the second grayscale, the luminance control transistor is turned off by the second sub-data signal of the pixel, such that the driving current flows to the first organic light emitting diode.

18. The display device of claim 12, wherein
the pixel further comprises:
a light emission control transistor connected between the driving transistor and a first voltage; and
a monitoring transistor connected between the corresponding data line and a node of the light emission control transistor and the driving transistor, and
the driving current generated in the driving transistor based on the first data voltage is transmitted through a turned-on monitoring transistor, and the first data voltage is controlled to allow the driving current to be substantially equal to a predetermined reference current.

19. A method for driving a pixel of a display device, the method comprising:
coupling a first organic light emitting diode and a second organic light emitting diode of the pixel in series in response to a first sub-data signal corresponding to a first grayscale supplied to the pixel, and flowing a driving current generated by a driving transistor of the pixel based on a first data voltage corresponding to the first grayscale to the first organic light emitting diode and the second organic light emitting diode; and
flowing the driving current generated by the driving transistor of the pixel based on a second data voltage corresponding to a second grayscale to the first organic light emitting diode in response to a second sub-data signal corresponding to the second grayscale supplied to the pixel.

20. The method for driving the pixel of claim 19, further comprising:
flowing a third driving current generated by the driving transistor of the pixel based on a third data voltage corresponding to a third grayscale to at least the first organic light emitting diode.
